(19) United States
(12) Patent Application Publication
(10) Pub. No.: US 2026/0339831 A1
(43) Pub. Date: Oct. 29, 2026

(54) DATABASE TESTING SERVICE

(71) Applicant: eBay Inc., San Jose, CA (US)

(72) Inventors: Douglas Wayne Hathaway, El Dorado Hills, CA (US); Li Zhengguan, Allen, TX (US); Timothy David Robison, Orangevale, CA (US); Ramashri Satish Umale, Campbell, CA (US); Steven Bruce West, Roseville, CA (US)

(73) Assignee: eBay Inc., San Jose, CA (US)

(21) Appl. No.: 19/189,354

(22) Filed: Apr. 25, 2025

(51) Int. Cl. G06F 11/3698; G06F 11/3668; G06F 16/2455

(52) U.S. Cl. CPC G06F 11/3698; G06F 11/3688; G06F 11/3692; G06F 16/24568

(57) ABSTRACT

A database testing service is described that enables comprehensive evaluation of database performance and behavior under real-world conditions. The database testing service supports concurrent testing of multiple test databases with respect to each other using a single stream of database requests. As these test databases process a same stream of database requests, the database testing service monitors and compares performance, response times, and other results in real-time. The database testing service can detect and log discrepancies in test results between the test databases, highlighting potential issues or inconsistencies that may arise from different configurations. The database testing service also includes functionality to log and replay database requests.

### BACKGROUND

Databases are structured collections of data implemented using storage devices and organized for efficient storage, retrieval, and management of data. Databases serve as a backbone for numerous computational functionalities implemented across a variety of scenarios that involve storing and processing vast amounts of data. Databases can range from small, localized systems used by individual businesses to massive, distributed systems supporting global operations for multinational corporations.

Because of this, database testing presents several technical challenges due to the complexity and underlying nature of these systems and wide range of usage scenarios. One technical challenge involves creating realistic test environments that accurately mimic production scenarios without compromising sensitive data or impacting live operations. Another technical challenge is caused by the sheer volume of data involved, which can make comprehensive testing time-consuming and resource intensive.

Performance testing under various load conditions and ensuring data integrity across distributed systems adds further layers of complexity and corresponding technical challenges. Further, conventional techniques used to test database migrations, upgrades, or structural changes are challenged with doing so without disrupting ongoing operations, which is often prone to error and therefore is typically responsible for service disruptions.

### SUMMARY

A database testing service is described that enables comprehensive evaluation of database performance and behavior under real-world conditions. The database testing service supports concurrent testing (e.g., in parallel) of multiple test databases with respect to each other using a single stream of database requests. This approach allows for simultaneous evaluation of different database configurations, optimizations, or structural changes. As these test databases process a same stream of database requests, the database testing service monitors and compares performance, response times, and other results in real-time. The database testing service can detect and log discrepancies in test results between the test databases, highlighting potential issues or inconsistencies that may arise from different configurations.

The database testing service also includes functionality to log and replay database requests. The database testing service, for instance, captures a database request as a test event, recording content of the database request along with a timestamp. For testing, the database testing service retrieves and replays a set of test events corresponding to a specified period of time. During replay, the database testing service uses the timestamps to maintain timing and sequence of the database requests, accurately recreating conditions present during the specified time frame. This capability supports various use cases, such as debugging issues that occurred during specific time periods, conducting detailed performance analysis, or creating reproducible test scenarios based on real production traffic patterns.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 is an illustration of an environment in an example implementation that is operable to employ database testing service techniques described herein.

FIG. 2 depicts a system in an example implementation showing operation of a database system of FIG. 1 in greater detail as implementing concurrent testing of a plurality of test databases.

FIG. 3 depicts a system in an example implementation showing operation of the database system of FIG. 2 in greater detail as implementing test result analysis of test results from the plurality of test databases.

FIG. 4 is a flow diagram depicting an algorithm as a step-by-step procedure in an example implementation of operations performable for accomplishing a result of concurrent testing of a plurality of test databases by a database testing service.

FIG. 5 depicts a system in an example implementation showing operation of a database system of FIG. 1 in greater detail as logging database requests as test events and using a set of the test events for testing operation of the test database and/or the production database.

FIG. 6 depicts an example implementation showing output of a user interface usable to provide an input specifying a period of time.

FIG. 7 depicts an example implementation showing output of a user interface usable to present a test result of FIG. 5.

FIG. 8 is a flow diagram depicting a step-by-step procedure in an example implementation of operations performable by a processing device for accomplishing a result of formation of a log of test events and use of the log to test operation of a test database for a period of time specified by an input.

FIG. 9 illustrates an example system including various components of an example device that can be implemented as any type of computing device as described and/or utilize with reference to FIGS. 1-8 to implement embodiments of the techniques described herein.

### DETAILED DESCRIPTION

### Overview

Databases employ storage devices to maintain and manage structured collections of data implemented and organized for efficient storage, retrieval, and management of data. Databases are employed in a variety of usage scenarios. Examples of database uses include e-commerce platforms (e.g., that manage product inventories, customer information, and transaction histories), healthcare systems (e.g., that store patient records, treatment plans, and medical research data), financial institutions (e.g., that handle account information, transactions, and regulatory compliance data), social media platforms (e.g., that manage user profiles, posts, and interaction data), and so forth.

In order to validate operation of a database and changes made to a database, a variety of testing techniques may be employed. Database testing, for instance, is usable to verify functionality, performance, integrity, and security of database systems and the applications that interact with the databases. Database testing, for instance, is used to ensure that databases reliably store, retrieve, and manage data while maintaining accuracy and consistency. Database testing is usable to validate that database requests execute correctly and efficiently, that data integrity constraints are enforced, and that the databases handle expected workloads and scale as encountered in real-world scenarios.

Database testing is also usable to verify that database migrations, upgrades, and structural changes are performable without data loss or corruption. Security testing may also be implemented to ensure that access controls are properly implemented and that sensitive data is protected. Performance testing is usable to optimize database request execution and resource utilization under various load conditions. Compatibility testing verifies that the database works correctly with different applications, middleware, and operating systems.

Conventional database testing techniques, however, face several significant technical challenges in order to address real-world scenarios. Simulation of representative test environments that accurately reflect production scenarios, for instance, is often difficult and resource-intensive, leading to incomplete or unrealistic testing. In practice, synthetic test data frequently fails to capture complexity and unpredictability of real-world data patterns, resulting in missed edge cases and potential operational issues. Performance testing under various load conditions is also technically challenging to simulate accurately, especially for large-scale distributed systems.

Testing database migrations or structural changes without disrupting live operations also poses considerable risks of service disruptions. An inability to easily reproduce specific error conditions or performance issues that occur in production environments hinders effective debugging and optimization. Additionally, maintaining test data consistency across multiple test environments and ensuring that test databases are synchronized with evolving production schemas present ongoing technical challenges. These limitations in conventional testing techniques can lead to undetected issues, reduced confidence in database changes, and increased risk when deploying updates to production environments, data inaccuracies, service disruptions, and inefficient use of computational resources.

Accordingly, database testing service techniques and systems are described that address these and other technical challenges. A database testing service as described herein offers several technical advantages over conventional testing techniques. The database testing service, for instance, provides a scalable, automated platform for comprehensive database testing without impacting use of a production database supporting a production environment. The database testing service is configurable to create realistic test scenarios using an actual stream of database requests, enabling increased accuracy and relevancy as part of testing.

The database testing service also allows for efficient performance testing under various load conditions to identify potential issues or bottlenecks. The database testing service facilitates reproduction of specific error conditions or performance issues, enhancing debugging and optimization processes. By automating many aspects of database testing, the database testing service reduces the time and resources involved in testing and thereby supporting increased testing frequency and comprehensive test cycles. In this way, the database testing service leads to higher confidence in database changes, reduced risk in deployments, and improved overall database reliability and performance in comparison with conventional techniques.

In one example implementation, the database testing service supports parallel testing of multiple test databases with respect to each other using a single stream of database requests. In this way, operation of the test databases may be evaluated with respect to each other, which is not possible in conventional techniques. Test databases, for instance, may be configured by making edits to operational parameters of a production database, e.g., different ranges of values for a particular parameter. Test results from the respective test databases may then be compared to each other and as such provide insight as to which option exhibits desired performance.

To do so in one or more examples, the database testing service mirrors incoming database traffic as a stream of database requests transmitted to a production database and simultaneously routes the stream to a plurality test databases, e.g., each configured with different parameters or structural changes. As these test databases process what in this instance is an identical stream of database requests, the database testing service monitors and compares test results indicating performance, response times, and other results of the test databases to each other in real-time. In this way, the database testing service supports testing of operation of testing databases to each other, in parallel, which is not possible in conventional techniques. This parallel testing approach supports efficient evaluation of multiple test database configurations or changes simultaneously to identify which setup exhibits the best performance, has operational issues, and so forth. Testing involving additional comparison of each of the test databases to operation of the production database is also contemplated.

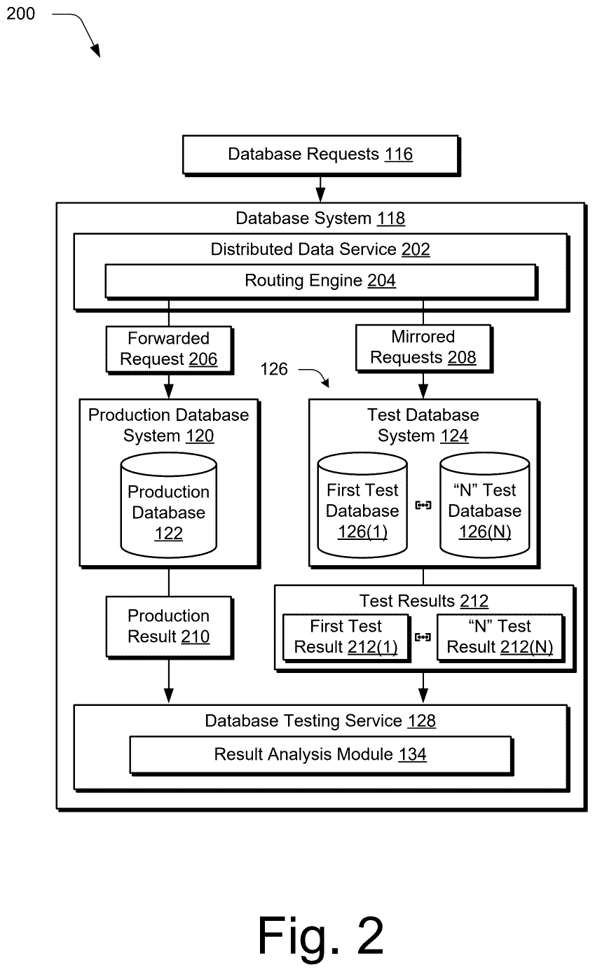

The database testing service may also detect and log discrepancies in test results between the test databases, highlighting potential issues or inconsistencies that may arise from different configurations. In this way, the database testing service significantly reduces time and resources utilized to test multiple database changes while providing comprehensive and comparative results as further described in relation to FIGS. 2-4.

In one or more other examples, the database testing service includes an ability to log and replay database requests. To do so in one or more examples, the database testing service captures each database request as a test event, recording content of the request along with a timestamp. These test events are stored in a persistent, scalable storage system. For testing, the database testing service retrieves and replays a set of test events corresponding to a specified period of time. An input, for instance, is received specifying a period of time (e.g., corresponding to an outage that occurred last week) and the database testing service obtains a set of test events having timestamps corresponding to the period of time.

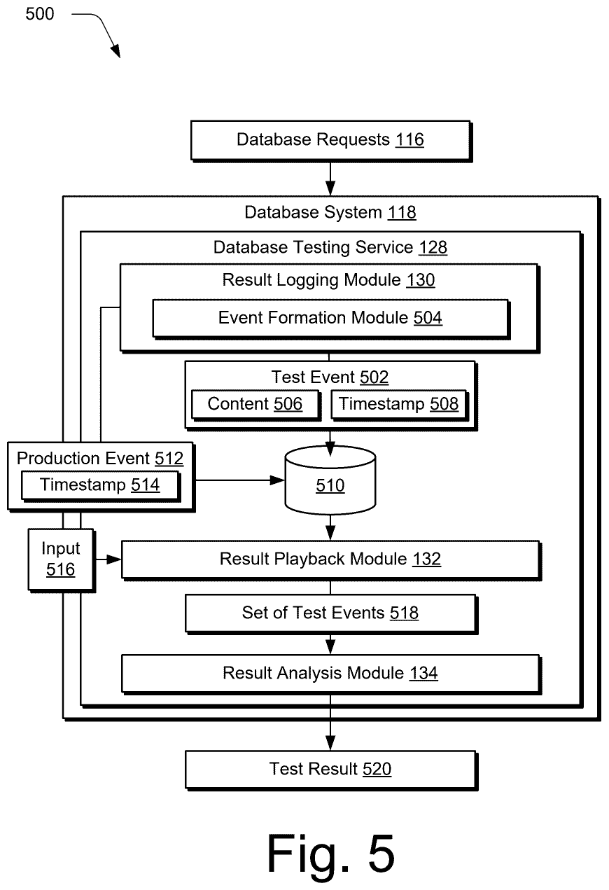

During replay, the database testing service may use the timestamps to maintain an original timing and sequence of the database requests, accurately recreating conditions present during the period of time. This capability supports a variety of functionalities, such as to debug issues that occurred during specific time frames, conduct detailed performance analysis, create reproducible test scenarios based on real production traffic patterns, and so forth. Additionally, an ability to replay test events at different speeds while maintaining relative timing also allows for accelerated testing, detailed slow-motion analysis of database behavior under various conditions, and so forth which is not possible in conventional techniques. Further discussion of logging of test events and testing using a replay of the test events is described in relation to FIGS. 5-8.

In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Example Database Testing Service Environment

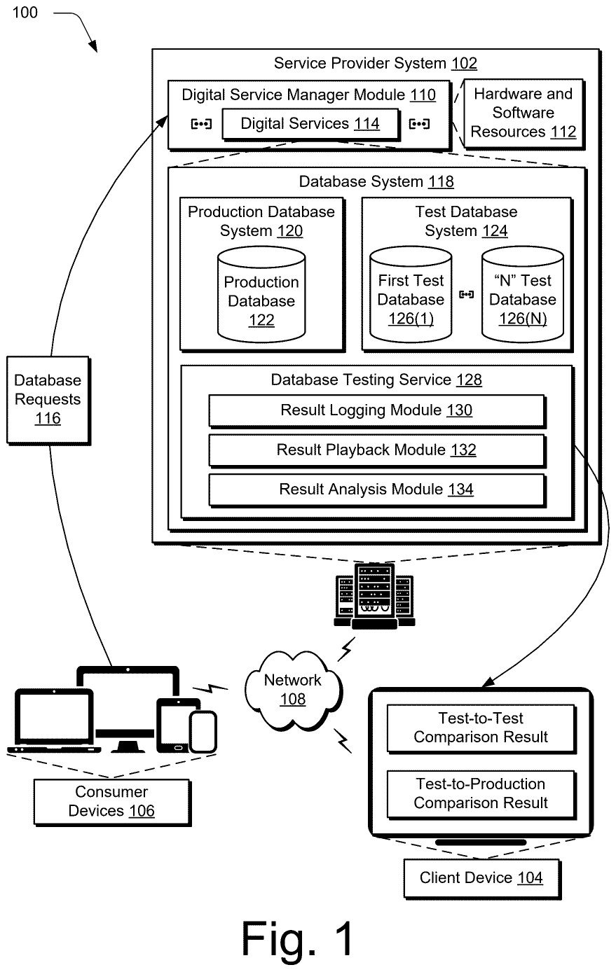

FIG. 1 is an illustration of a digital medium environment 100 in an example implementation that is operable to employ database testing service techniques described herein. The illustrated environment 100 includes a service provider system 102, a client device 104, and consumer devices 106 that are communicatively coupled, one to another, via a network 108. Computing devices that implement the service provider system 102, client device 104, and consumer devices 106 are configurable in a variety of ways.

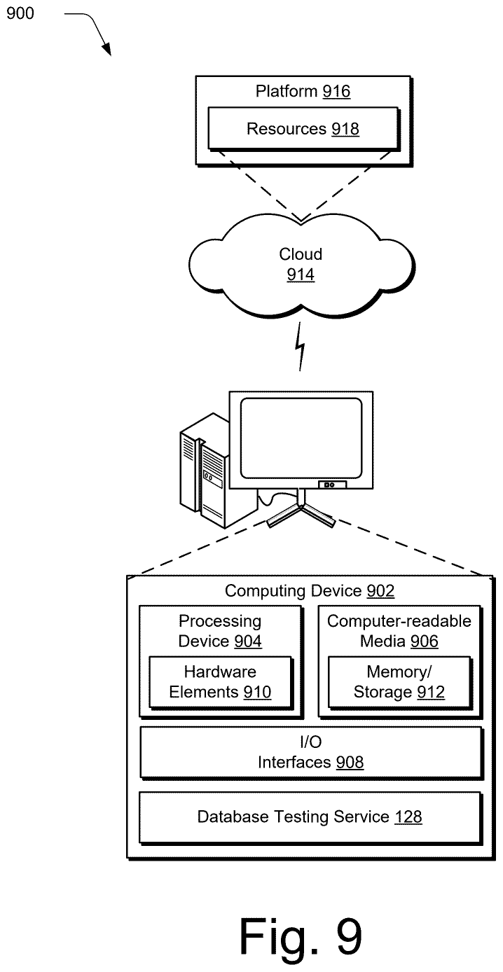

A computing device, for instance, is configurable as a desktop computer, a laptop computer, a mobile device (e.g., assuming a handheld configuration such as a tablet or mobile phone), and so forth. Thus, a computing device ranges from full resource devices with substantial memory and processor resources (e.g., personal computers, game consoles) to a low-resource device with limited memory and/or processing resources (e.g., mobile devices). Additionally, although a single computing device is shown and described in instances in the following discussion, a computing device is also representative of a plurality of different devices, such as multiple servers utilized by a business to perform operations “over the cloud” for the service provider system 102 and as further described in relation to FIG. 9.

The service provider system 102 includes a digital service manager module 110 that is implemented using hardware and software resources 112 (e.g., a processing device and computer-readable storage medium) in support one or more digital services 114. Digital services 114 are made available, remotely, via the network 108 to computing devices, e.g., consumer devices 106, client device 104, and so forth.

Digital services 114 are scalable through implementation by the hardware and software resources 112 and support a variety of functionalities, including accessibility, verification, real-time processing, analytics, load balancing, and so forth. Examples of digital services include a social media service, streaming service, digital content repository service, content collaboration service, and so on. Accordingly, in the illustrated example, a communication module (e.g., browser, network-enabled application, and so on) is utilized by the consumer devices to access the one or more digital services 114 via the network 108, e.g., via a stream of database requests 116. A result of processing using the digital services 114 is then returned, respectively, to the consumer devices 106 via the network 108, e.g., as database responses as further described below.

In the illustrated example, the digital services 114 are utilized to implement a database system 118. The database system 118 is illustrated in this example to implement a production database system 120 having a production database 122 and a test database system 124 having a plurality of test databases, examples of which are illustrated as a first test database 126(1), . . . , through an “N” test database 126(N). In the following discussion, reference to a single one of the test databases or the plurality of test databases as a collection may be made as test database 126.

The production database 122 and the plurality of test databases 126 are configurable in a variety of ways. Examples of which include relational databases include “MySQL” and “PostgreSQL” that use structured query language (SQL) for defining and manipulating data, ensuring ACID (atomicity, consistency, isolation, durability) compliance for transaction reliability. “NoSQL” databases (e.g., “MongoDB” and “Cassandra”) offer flexibility in handling unstructured data, providing high scalability and performance for large-scale applications. In-memory databases like “Redis” and “Memcached” store data in rapid access memory (RAM) for rapid access in support of caching and real-time analytics. Distributed databases ensure data availability and fault tolerance across multiple nodes, supporting global applications. Each configuration, whether single-node, clustered, or distributed, addresses specific criteria for data integrity, speed, and scalability.

The database system 118 further includes a database testing service 128 which is configurable to implement a variety of techniques usable to test operation of the production database 122 and/or the test database 126. A variety of techniques may be used as part of database testing by the database testing service 128. “Functional testing” is usable to verify that database operations such as inserts, updates, deletes, and queries operate as intended and produce expected results. Functional testing includes testing data integrity constraints, triggers, stored procedures, and complex queries.

“Performance testing” is usable to evaluate response time of a database, throughput, and resource utilization under various load conditions, including stress testing to identify bottlenecks and scalability limits. “Concurrency testing” is usable by the database testing service 128 to monitor how a database handles multiple simultaneous transactions and ensures proper locking and isolation levels are maintained.

“Security testing” is usable by the database testing service 128 to assess access controls, encryption mechanisms, and vulnerability to SQL injection and other attacks. “Recovery testing” verifies an ability of a database to recover from crashes, power failures, or other unexpected interruptions without data loss. “Backup and restore testing” ensures that data is reliably backed up and restored as relevant. “Migration testing” is usable by the database testing service 128 to validate that data can be accurately moved between different database versions or even different database management systems. “Compatibility testing” checks interaction of the database with various applications, APIs, and client libraries. “Regression testing” is performed after changes are made to ensure that existing functionality remains intact and that bug fixes don't introduce new issues. A variety of other examples are also contemplated.

The database testing service 128 is configurable to employ a variety of functionalities in support of the above testing techniques, examples of which to do so include a result logging module 130, a result playback module 132, and a result analysis module 134, e.g., for testing. The result logging module 130, for instance, intercepts database requests 116 sent to a production database 122. The intercepted database requests 116 are then logged as test events. For each intercepted database request 116, the result logging module 130 captures content of the database request, e.g., query text, parameters, and any associated metadata. The result logging module 130 also records a timestamp indicating when the request was intercepted, received by the service provider system 102, sent by the consumer devices 106, and so on.

The result logging module 130 then stores these test events in a persistent storage system, organizing the test events in a manner such that an original sequence may be identified. The result logging module 130, for instance, may utilize a scalable storage techniques, such as a distributed message queue or time-series database, to handle high volumes of requests. In addition to logging individual requests, the result logging module 130 may also capture contextual information about the database state or application environment of the digital services 114 at the time of interception. This comprehensive logging approach enables accurate reproduction of database workloads and facilitates detailed analysis of database performance and behavior over time.

A result playback module 132 may then retrieve and replay test events to test the operation of databases. The result playback module 132 accesses a repository of stored test events, each containing the content of a database request and its associated timestamp. When instructed to perform a replay, the result playback module 132 processes these test events in a manner that preserves an original timing and sequence of the requests, allowing for accurate recreation of specific database workloads or scenarios.

For example, the result playback module 132 may receive an input specifying a particular period of time, such as “Mar. 15, 2025, from 2:00 PM to 4:00 PM UTC.” Based on this input, the result playback module 132 queries a storage device to fetch events with timestamps falling within the specified time range. The result playback module 132 then initiates the replay process, sending each database request to the test database 126 while maintaining relative timing between requests as indicated by the timestamps. If the original database requests 116 were received fifty milliseconds apart, for instances, the result playback module 132 ensures that a set of test events are replayed with a matching fifty-millisecond interval. Timing preservation supports accurate reproduction of database behavior, including potential race conditions, concurrency issues, or performance characteristics that may be time dependent.

A result analysis module 134 may perform comprehensive testing of a test database 126 using a variety of techniques. In a first example, the result analysis module 134 utilizes a log of test events to conduct thorough analysis and validation. The result analysis module 134 retrieves a set of test events from the log, each containing the content of a database request and its associated timestamp. The result analysis module 134 then executes these requests against the test database 126 and maintains timing between requests through use of the result playback module 132. As each request is processed, the result analysis module 134 generates test results by capturing detailed metrics such as query execution time, resource utilization, and result sets. These metrics, for instance, may be compared to identify any deviations or performance issues.

For instance, the result analysis module 134 may replay a sequence of test events corresponding to a high-traffic period that previously caused performance degradation in a production environment. By executing the test events on the test database 126, the result analysis module 134 evaluates whether recent optimizations or configuration changes have resolved the issue. In another scenario, the result analysis module 134 replays a series of test events that led to a data inconsistency in the past, verifying that data integrity constraints and transaction handling have been improved to prevent similar issues.

In a second example, the result analysis module 134 performs concurrent testing on a plurality of test databases 126 using a stream of database requests 116. This approach may utilize either the logged test events from the first example or real-time requests mirrored as intercepted during communication to a production database 122. A distributed data service, for instance, may be employed to simultaneously routes each incoming request to each of the test databases 126 under evaluation, which may have different configurations, optimizations, or structural changes applied. As the database requests 116 are processed, the result analysis module 134 collects performance metrics and result sets from each test database 126 in parallel.

This concurrent testing techniques allows for direct comparison of different database configurations or versions under identical workloads of the test database 126 in relation to each other. For example, the result analysis module 134 may evaluate an impact of various indexing strategies by applying different index configurations to each test database 126 and compare query execution times and resource usage.

In another scenario, the result analysis module 134 tests effectiveness of different caching mechanisms or query optimization techniques across the test databases 126. By analyzing the results in real-time, the result analysis module 134 may efficiently identify which configuration yields the best performance for specific types of queries or workload patterns. This approach significantly reduces time and resources used to evaluate multiple database changes or optimizations, supporting increased agility and data-driven decision-making in database management and optimization processes, which is not possible in conventional techniques.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Example Concurrent Testing of a Plurality of Test Databases

The following discussion describes database testing service techniques that are implementable utilizing the described systems and devices. Aspects of each of the procedures are implemented in hardware, firmware, software, or a combination thereof. The procedures are shown as a set of blocks that specify operations performable by hardware and are not necessarily limited to the orders shown for performing the operations by the respective blocks. Blocks of the procedures, for instance, specify operations programmable by hardware (e.g., processor, microprocessor, controller, firmware) as instructions thereby creating a special purpose machine for carrying out an algorithm as illustrated by the flow diagram. As a result, the instructions are storable on a computer-readable storage medium that causes the hardware to perform the algorithm.

FIG. 2 depicts a system 200 in an example implementation showing operation of the database system 118 of FIG. 1 in greater detail as implementing concurrent testing of a plurality of test databases 126. In this example, a stream of database requests 116 are received by a database system 118. A distributed data service 202 is then employed to utilize a routing engine 204 to transmit a forwarded request 206 to a production database system 120 and mirrored requests 208 to each of the plurality of test databases 126 of the test database system 124. The distributed data service 202, for instance, may act as a proxy of production database 122, forwarding the stream of database requests 116 as the forwarded requests 206 to the production database 122. A stream of requests refers to a series of requests that are received over a period of time and which are processed in turn.

In order to generate the mirrored requests 208, the distributed data service 202 intercepts database traffic targeted towards a production database 122, i.e., the database requests 116. The distributed data service 202 acts as a proxy, receiving incoming database requests from the consumer devices 106. As each database request 116 is transmitted and processed by the distributed data service 202 to the production database 122, the distributed data service 202 creates mirrored requests 208 as copies of the database requests 116, including query parameters, metadata, and associated context.

The mirrored requests 208 are then transmitted to one or more test databases in parallel with the forwarded request 206 being sent to the production database 122. The distributed data service 202, through use of the routing engine 204, may use various networking techniques to efficiently duplicate and route the traffic, such as multicast protocols or separate TCP connections for each destination. To maintain consistency and allow for accurate performance comparisons, the distributed data service 202 may preserve original timing and order of the database requests 116 when forwarding to the test databases 126. The distributed data service 202 may also add additional metadata to the mirrored requests, such as timestamps or unique identifiers, to facilitate tracking and analysis of the database requests 116 as being processed through the database system 118.

The forwarded request 206 is then processed by the production database 122 to produce a production result 210, i.e., a database response to a database request. In parallel, the plurality of test databases 126 including the first test database 126(1), . . . , through the “N” test database 126(N) output test results 212, examples of which are depicted respectively as first test result 212(1), . . . , through “N” test result 212(N) .

Test results 212 output by the test databases 126 of the test database system 124 may encompass a wide range of metrics and indicators. For functional testing, output test results 212 may include success rates of insert, update, delete, and query operations, verification of data integrity constraints, proper execution of triggers and stored procedures, and correct output from complex queries. Performance test results may show response times for various query types, overall system throughput under different load conditions, CPU and memory utilization, I/O operations per second, and identification of performance bottlenecks. Concurrency test results may indicate the number of simultaneous transactions successfully processed, occurrence of deadlocks or race conditions, and verification of proper isolation levels.

Security test results may include reports on unauthorized access attempts, encryption effectiveness, and successful or failed SQL injection attacks. Recovery test results may show data consistency and availability after simulated crashes or power failures. Backup and restore test results may indicate the time taken for backup and restore operations and data integrity post-restoration. Migration test results may show data accuracy and completeness after moving between database versions or systems. Compatibility test results may include success rates of interactions with different applications, A Pls, and client libraries. Regression test results may highlight any unintended side effects or reintroduced bugs following recent changes or fixes to the database system. A variety of other examples are also contemplated. Further, the production result 210 may also include test results in a manner similar to that described for the test results 212 above.

The test results 212 are then communicated to the database testing service 128 and processed using a result analysis module 134 to analyze operation of the plurality of test databases 126 in relation to each other, in relation to operation of the production database 122, and so forth. Further discussion of this example is included in the following description and shown in a corresponding figure.

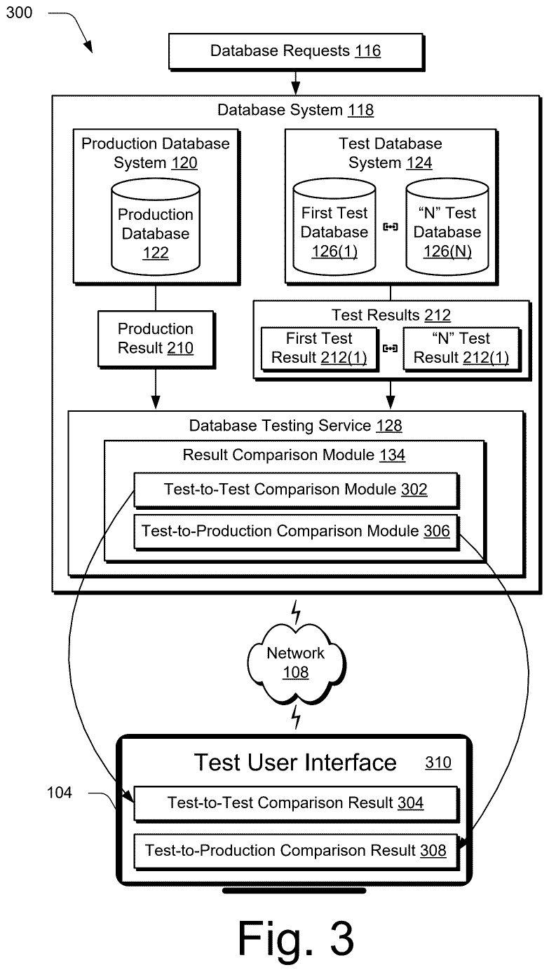

FIG. 3 depicts a system 300 in an example implementation showing operation of the database system 118 of FIG. 1 in greater detail as implementing test result analysis of operation of the plurality of test databases 126. The result analysis module 134 is configurable to implement a variety of testing techniques as previously described above. Further, these testing techniques may employ a variety of comparisons, examples of which are represented in FIG. 3 as a test-to-test comparison module 302 to generate a test-to-test comparison result 304 and a test-to-production comparison module 306 configured to generate a test-to-production comparison result 308.

In a test-to-test comparison example, the test-to-test comparison result 304 may support a variety of insights supported by analysis of respective test results 212 and configurations of respective test databases 126 that generated the results. Comparison of test results 212 from multiple test databases 126, for instance, provides valuable insights into database performance, behavior, and optimization opportunities. For example, when testing different indexing strategies, the test-to-test comparison result 304 may reveal that one configuration significantly reduces query execution time for complex joins, while another performs better for simple lookups. This insight supports informed decision making about index design based on the specific workload patterns.

The comparison may also uncover unexpected interactions between different database settings. For instance, the test results 212 may show that increasing a buffer pool size improves performance for one database configuration but has minimal impact on another due to differences in query optimization strategies. By analyzing these differences, a deeper understanding is supported by the database system 118 as to how various database parameters and changes to those parameters for respective test databases 126 influence overall system performance. Additionally, comparing results across multiple test databases may help to identify configuration changes that provide consistent improvements across a wide range of database requests 116 versus those that solely benefit specific types of operations, e.g., for optimizing databases that handle diverse workloads.

Parallel testing of multiple test databases 126 may also reveal scalability characteristics under different conditions. For example, the test results 212 may show that one configuration of a first test database 126(1) maintains consistent performance as the data volume grows, while another configuration by an “N” test database 126(N) begins to degrade rapidly past a certain threshold. This insight supports capacity planning and choice of configurations that support future growth. Furthermore, comparing test results may highlight differences in how various database configurations handle concurrency. A first setup by the first test database 126(1), for instance, may excel at handling a multitude of small, concurrent transactions, while a second set by the “N” test database 126(N) is better suited for fewer but increasingly complex queries.

The result analysis module 134 also supports a test-to-production comparison module 306 to generate a test-to-production comparison result 308. Comparing test results 212 from multiple test databases 126 individually with the production result 210 of the production database 122 may provide valuable insights into the impact of various configuration changes and optimizations. For example, this comparison may reveal that while one test database configuration improves performance for certain types of queries compared to the production database, that test database configuration may degrade performance for others. This granular analysis supports an understanding of trade-offs associated with each configuration change and informed decisions based on specific workload priorities. Additionally, comparing each test database against the production database 122 may help identify unexpected side effects of configuration changes that are not otherwise apparent when solely comparing test databases to each other.

The comparison of the test results 212 with production result 210 may also highlight differences in resource utilization patterns. A test database 126, for instance, may show improved query performance but at the cost of higher CPU or memory usage compared to the production database 122. This insight supports capacity planning and ensures that performance improvements do not lead to resource constraints in production environments. Furthermore, comparing test databases 126 individually with the production database 122 may reveal how different configurations handle data growth and changing query patterns over time, providing insight that supports long-term database management strategies.

Additional insights can be gained by comparing the operation of a test database 126 with a production database 122 beyond solely comparing test results. For instance, observing how each test database 126 and production database 122 handles peak load periods or sudden spikes in traffic can reveal differences in scalability and resilience. A test database 126, for instance, may perform well under normal conditions but struggle to maintain performance during high-concurrency scenarios that are well handled by the production database 122. This operational comparison by the result analysis module 134 may also uncover differences in how various database configurations impact other systems or services in the overall application architecture, which might not be apparent from isolated test results.

Moreover, comparing the operational characteristics of test and production databases may also provide insights into maintenance and administrative tasks. For example, this comparison may reveal that a particular test configuration significantly reduces the time involved in performing routine tasks such as index rebuilds or statistics updates compared to the production database. This information may be valuable in optimizing database maintenance windows and reducing overall system downtime. Additionally, observing how test and production databases behave during simulated failure scenarios or during actual unplanned outages may provide insights into robustness and recoverability of different database configurations, helping to improve overall system reliability and disaster recovery strategies. A variety of other examples are also contemplated.

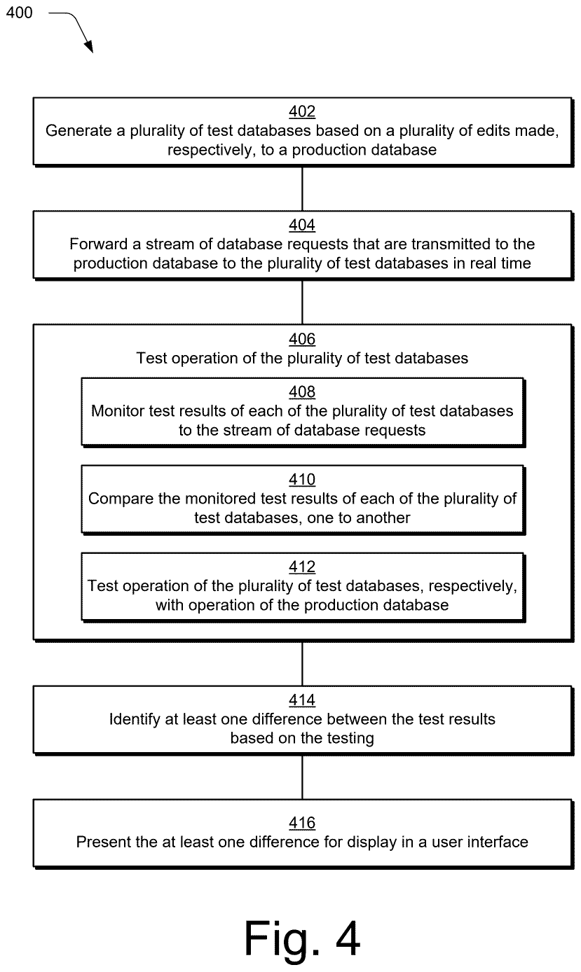

FIG. 4 is a flow diagram depicting an algorithm 400 as a step-by-step procedure in an example implementation of operations performable for accomplishing a result of concurrent testing of a plurality of test databases by a database testing service. To begin in this example, a plurality of test databases 126 are generated based on a plurality of edits made, respectively, to a production database 122 (block 402). The database system 118, for instance, may create multiple test database 126 instances, each configured with a different set of modifications or configuration changes derived from the production database 122. These edits may include alterations to database schema, index structures, query optimization settings, or other parameters that potentially impact database performance or behavior. By creating multiple test databases 126 with varied configurations, the database testing service 128 enables parallel testing of different optimization strategies or proposed changes.

A stream of database requests that are transmitted to a production database 122 are forwarded to a plurality of test databases 126 in real time (block 404), e.g., as mirrored requests 208. The database system 118, for instance, utilizes a distributed data service 202 to intercept and replicate the incoming database traffic configured as a stream of database requests 116 that are targeted for the production database 122. The mirrored requests 208 are simultaneously routed to each of the test databases 126, ensuring receipt of identical workloads in real-time. This approach maintains the genuine patterns, variability, and unpredictability of real-world database usage.

Operation of the plurality of test databases is tested, one to another (block 406) by a result analysis module 134 of the database testing service 128. Testing includes monitoring test results 212 of each of the plurality of test databases 126 to the stream of database requests (block 408). As the database requests 116 (i.e., the mirrored requests 208) are processed by each test database 126, the database testing service 128 monitors various performance metrics and operational characteristics. Examples of these metrics include query execution times, resource utilization patterns, transaction throughput, and other relevant indicators of database performance. The database testing service 128 may also capture detailed telemetry data from each test database 126, allowing for comprehensive analysis of how each configuration responds to the real-world workload.

The monitored test results of each of the plurality of test databases are then compared, one to another (block 410) by a result analysis module 134 of the database testing service 128. The result analysis module 134, for instance, performs a comparative analysis of the collected performance data described by the test results 212 for each of the plurality of test databases 126, one to another. This comparison may include statistical analysis of query response times, evaluation of resource efficiency, assessment of scalability under varying load conditions, and identification of anomalies or unexpected behaviors. As part of this, the result analysis module 134 may employ rule-based algorithms or machine learning techniques to discern meaningful patterns or performance differentials between the various database configurations.

Additionally, in this example, operation of the plurality of test databases is tested, respectively, with respect to operation of the production database (block 412). Beyond comparing operation of the test databases 126 to each other, the database testing service 128 through use of the result analysis module 134 is also configurable to evaluate each test configuration of the test databases 126 against the performance of the production database 122. This comparison provides context, allowing the database system 118 to determine whether proposed changes offer tangible improvements over a current production environment. The analysis may consider factors such as overall throughput, specific query performance, resource utilization efficiency, an ability to handle peak loads or unusual traffic patterns, and so forth.

In this example, at least one difference is identified by the result analysis module 134 between the test results based on the testing (block 414). Through comprehensive analysis, for instance, the database testing service 128 identifies significant variations in performance or behavior among the test databases 126, which may also be performed in comparison to the production database 122. These differences may be exhibited as improvements in query execution speed, enhanced concurrency handling, efficient resource utilization, or other measurable benefits. Conversely, the database testing service 128 may also flag configurations that lead to performance degradation, increased error rates, or other undesirable outcomes.

The difference is then presented for display in a user interface (block 416). The database testing service 128, for instance, may generate a clear, informative visualization of the identified differences for presentation in a user interface 310. This user interface 310 may include interactive graphs, comparative charts, and detailed performance breakdowns that highlight the relative strengths and weaknesses of each tested configuration, and so on. In this way, the presentation of the difference may facilitate informed decision-making, allowing a quick grasp of implications of various database modifications and selection of a beneficial configuration for a specific use case. A variety of other examples are also contemplated.

### Example Logging of Database Requests As Test E Vents

The following discussion describes logging techniques of database requests as test events that are implementable utilizing the described systems and devices. Aspects of each of the procedures are implemented in hardware, firmware, software, or a combination thereof. The procedures are shown as a set of blocks that specify operations performable by hardware and are not necessarily limited to the orders shown for performing the operations by the respective blocks. Blocks of the procedures, for instance, specify operations programmable by hardware (e.g., processor, microprocessor, controller, firmware) as instructions thereby creating a special purpose machine for carrying out an algorithm as illustrated by the flow diagram. As a result, the instructions are storable on a computer-readable storage medium that causes the hardware to perform the algorithm.

FIG. 5 depicts a system 500 in an example implementation showing operation of the database system 118 of FIG. 1 in greater detail as logging database requests as test events and using a set of test events for testing operation of the test database 126 and/or the production database 122. To begin in this example, a streams of database requests 116 is received by the database system 118. A result logging module 130 of the database testing service 128 is then employed to generate a test event 502. To do so, an event formation module 504 identifies content 506 included in the database requests 116 (e.g., which may include associated parameters and metadata) and assigns a timestamp 508, e.g., based on when the database requests 116 are received. A test event 502 in this example is generated for each respective database request 116 and stored in a storage device 510.

In an implementation, the result logging module 130 is also configured to log a production event 512 and corresponding timestamp 514. The production event 512, for instance, is generated based on the production result 210 from the production database 122 and includes a timestamp 514, e.g., when the database requests 116 was received by the production database 122, when the production event 512 is generated, when the production event 512 is received by the module 130 from the production database 122, and so forth. In this way, the log also describes a result of processing of the database requests 116 by the production database 122, which may support further insight as further described below.

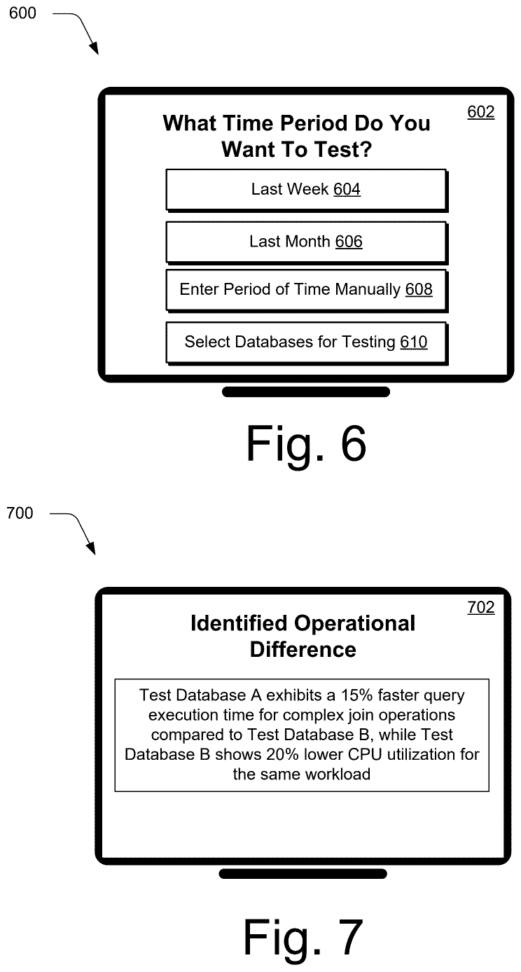

A result playback module 132 then receives an input 516 via a user interface specifying a period of time, for which, operation of the test database 126 is to be evaluated. FIG. 6 depicts an example implementation 600 showing output of a user interface 602 usable to provide an input the period of time. The user interface 602 includes a plurality of preconfigured options that are selectable to specify the amount of time, e.g., last week 604 and last month 606. The user interface 602 also includes an option to enter period of time manually 608, e.g., through use of a spoken utterance, keyboard entry, and so forth. An option is further included to select databases for testing 610, e.g., to select particular ones of the test databases 126 and/or the production database 122.

Returning again to FIG. 5, the result playback module 132, based on the input 516, obtains a set of test events 518 that correspond to the period of time. The result playback module 132 then replays the set of test events 518, e.g., to the selected test databases 126 and/or production database 122. A result analysis module 134 is then employed to generate a test result 520 indicating differences in operation detected by the test databases 126.

FIG. 7 depicts an example implementation 700 showing output of a user interface 702 usable to present a test result 520 of FIG. 5. In this example, the user interface 702 is configured to identify an operation difference in operation of a Test Database A and a Test Database B. The user interface 702 includes text indicating “Test Database A exhibits a 15% faster query execution time for complex join operations compared to Test Database B, while Test Database B shows 20% lower CPU utilization for the same workload.” In this way, the database system 118 supports testing using historical data for a specified period of time through use of the test event 502. Further discussion of operation of the module 130, result playback module 132, and result analysis module 134 may be found in relation to the following figure discussion and shown in a corresponding figure.

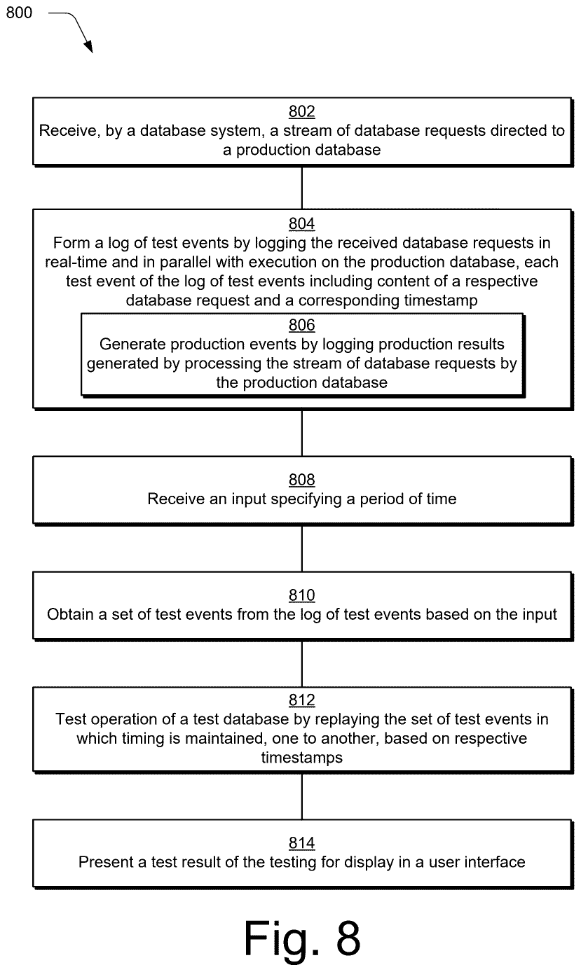

FIG. 8 is a flow diagram depicting a step-by-step procedure 800 in an example implementation of operations performable by a processing device for accomplishing a result of formation of a log of test events and use of the log to test operation of a test database for a period of time specified by an input. To begin in this example, a stream of database requests directed to a production database are received (block 802), e.g., are intercepted. A distributed data service 202, for instance, may intercept these database requests 116 as transmitted to the production database 122. The requests may originate from various client applications or other sources such as the consumer devices 106, representing real-world database traffic with its inherent variability in volume, complexity, and timing.

A log of test events 502 is formed by logging the received database requests 116 in real-time and in parallel with execution on the production database 122. Each test event 502 of the log of test events includes content 506 of a respective database request 116 and a corresponding timestamp 508 (block 804). A result logging module 130, for instance, captures each intercepted database request and records content including parameters, and associated metadata. The result logging module 130 also assigns a timestamp to each test event 502, indicating when a respective database request 116 was intercepted or received by the database testing service 128. These test events 502 are then stored in a storage device 510, organized in a manner that preserves sequential and temporal relationships.

In an implementation, production events are also generated by logging production results generated by processing the stream of database request by the production database 122 (block 806). As previously described, the production events provide insight in operation of the production database 122 “at the time” and therefore provide additional insight and avoid increased consumption of computational resources otherwise caused by repeating generation of the production results 210.

An input 516 is then received specifying a period of time (block 808) for testing. This input may be provided through a user interface 602, allowing a user to select a specific time range for analysis. For example, a user might specify “last week” or “Mar. 15, 2025, from 2:00 PM to 4:00 PM UTC” as the period of time that is to be tested. This flexibility supports targeted testing and analysis of database behavior during specific timeframes, such as peak load periods or when known issues occurred.

In response, a set of test events are obtained from the log of test events based on the input (block 810). A result playback module 132 queries the stored log of test events to retrieve test events 502 with timestamps falling within the specified time range. This set of test events represents a precise snapshot of the database activity during the period of interest, including the exact sequence and timing of requests.

Operation of a test database is tested by replaying the set of test events 518 in which timing is maintained, one to another, based on respective timestamps 508 (block 812). The result playback module 132, for instance, executes each test event against the test database 126 while preserving original timing between 116 as indicated by respective timestamps. This approach ensures that the test database 126 experiences a same workload pattern, including concurrency or timing-related scenarios, as the production database 122 did during the specified period.

A test result of the testing is then presented for display in a user interface (block 814). A result analysis module 134, for instance, collects and analyzes performance metrics, query execution times, resource utilization data, and other relevant information from the test database during the replay process. This data is then processed and presented in a user-friendly format, such as interactive graphs, charts, or detailed reports, allowing database administrators to easily interpret the results and make informed decisions about database optimizations or configuration changes. The test result 520, as previously described, may support testing of a single test database 126 alone, concurrent testing of a plurality of test database 126 together, testing of a test database 126 with that of the production database 122 through use of a production event 512 and corresponding timestamp 514, and so forth.

The database testing service 128 as described herein offers several technical advantages over conventional testing techniques. The database testing service 128 provides a scalable, automated platform for comprehensive database testing without impacting the operation of a production database 122. By utilizing actual streams of database requests, the database testing service 128 enables creation of realistic test scenarios with increased accuracy and relevancy. This approach allows for efficient performance testing under various load conditions to identify potential issues or bottlenecks.

The database testing service 128 also facilitates reproduction of specific error conditions or performance issues, enhancing debugging and optimization processes. By automating aspects of database testing, the database testing service 128 reduces time and resources involved in testing, supporting increased testing frequency and comprehensive test cycles. These capabilities lead to higher confidence in database changes, reduced risk in deployments, and improved overall database reliability and performance compared to conventional techniques.

Furthermore, an ability of the database testing service 128 to support parallel testing of multiple database configurations using a single stream of requests provides unique insights which are not possible using conventional techniques. Concurrent testing and analysis of multiple test databases, for instance, allows for direct comparison of different optimization strategies, configuration changes, or even different database systems under identical real-world workloads. This feature, combined with the logging and replay capabilities supported by the database testing service 128, supports data-driven decisions about database tuning, migration strategies, and architectural changes. Further, an approach of the database testing service 128 towards maintaining data consistency between production and test environments, along with an ability to seamlessly transition traffic to better-performing configurations, minimizes downtime and risk associated with database changes. Overall, these technical advantages significantly enhance an ability to maintain, optimize, and evolve database systems in response to changing criteria and workloads as previously described.

### Example System and Device

FIG. 9 illustrates an example system generally at 900 that includes an example computing device 902 that is representative of one or more computing systems and/or devices that implement the various techniques described herein. This is illustrated through inclusion of the database testing service 128. The computing device 902 is configurable, for example, as a server of a service provider, a device associated with a client (e.g., a client device), an on-chip system, and/or any other suitable computing device or computing system.

The example computing device 902 as illustrated includes a processing device 904, one or more computer-readable media 906, and one or more I/O interface 908 that are communicatively coupled, one to another. Although not shown, the computing device 902 further includes a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing device 904 is representative of functionality to perform one or more operations using hardware. Accordingly, the processing device 904 is illustrated as including hardware element 910 that is configurable as processors, functional blocks, and so forth. This includes implementation in hardware as an application specific integrated circuit or other logic device formed using one or more semiconductors. The hardware elements 910 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically-executable instructions.

The computer-readable storage media 906 is illustrated as including memory/storage 912 that stores instructions that are executable to cause the processing device 904 to perform operations. The computer-readable storage medium is configured for storing instructions that, responsive to execution by the processing device, causes the processing device to perform operations. The memory/storage 912 represents memory/storage capacity associated with one or more computer-readable media. The memory/storage 912 includes volatile media (such as random access memory (RAM) ) and/or nonvolatile media (such as read only memory (ROM) , Flash memory, optical disks, magnetic disks, and so forth). The memory/storage 912 includes fixed media (e.g., RAM, ROM, a fixed hard drive, and so on) as well as removable media (e.g., Flash memory, a removable hard drive, an optical disc, and so forth). The computer-readable media 906 is configurable in a variety of other ways as further described below.

Input/output interface(s) 908 are representative of functionality to allow a user to enter commands and information to computing device 902, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 902 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on a variety of commercial computing platforms having a variety of processors.

An implementation of the described modules and techniques is stored on or transmitted across some form of computer-readable media. The computer-readable media includes a variety of media that is accessed by the computing device 902. By way of example, and not limitation, computer-readable media includes “computer-readable storage media” and “computer-readable signal media.”

“Computer-readable storage media” refers to media and/or devices that enable persistent and/or non-transitory storage of information (e.g., instructions are stored thereon that are executable by a processing device) in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium that is configured to transmit instructions to the hardware of the computing device 902, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 910 and computer-readable media 906 are representative of modules, programmable device logic and/or fixed device logic implemented in a hardware form that are employed in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also be employed to implement various techniques described herein. Accordingly, software, hardware, or executable modules are implemented as one or more instructions and/or logic embodied on some form of computer-readable storage media and/or by one or more hardware elements 910. The computing device 902 is configured to implement particular instructions and/or functions corresponding to the software and/or hardware modules. Accordingly, implementation of a module that is executable by the computing device 902 as software is achieved at least partially in hardware, e.g., through use of computer-readable storage media and/or hardware elements 910 of the processing device 904. The instructions and/or functions are executable/operable by one or more articles of manufacture (for example, one or more computing devices 902 and/or processing devices 904) to implement techniques, modules, and examples described herein.

The techniques described herein are supported by various configurations of the computing device 902 and are not limited to the specific examples of the techniques described herein. This functionality is also implementable all or in part through use of a distributed system, such as over a “cloud” 914 via a platform 916 as described below.

The cloud 914 includes and/or is representative of a platform 916 for resources 918. The platform 916 abstracts underlying functionality of hardware (e.g., servers) and software resources of the cloud 914. The resources 918 include applications and/or data that can be utilized while computer processing is executed on servers that are remote from the computing device 902. Resources 918 can also include services provided over the Internet and/or through a subscriber network, such as a cellular or Wi-Fi network.

The platform 916 abstracts resources and functions to connect the computing device 902 with other computing devices. The platform 916 also serves to abstract scaling of resources to provide a corresponding level of scale to encountered demand for the resources 918 that are implemented via the platform 916. Accordingly, in an interconnected device embodiment, implementation of functionality described herein is distributable throughout the system 900. For example, the functionality is implementable in part on the computing device 902 as well as via the platform 916 that abstracts the functionality of the cloud 914.

In implementations, the platform 916 employs a “machine-learning model” that is configured to implement the techniques described herein. A machine-learning model refers to a computer representation that can be tuned (e.g., trained and retrained) based on inputs to approximate unknown functions. In particular, the term machine-learning model can include a model that utilizes algorithms to learn from, and make predictions on, known data by analyzing training data to learn and relearn to generate outputs that reflect patterns and attributes of the training data. Examples of machine-learning models include neural networks, convolutional neural networks (CNNs), long short-term memory (LSTM) neural networks, decision trees, and so forth.

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

1. A method comprising:
receiving, by a database system, a stream of database requests directed to a production database;
forming a log of test events by logging the received database requests in real-time and in parallel with execution on the production database, each test event of the log of test events including content of a respective said database request and a corresponding timestamp;
receiving an input specifying a period of time;
obtaining a set of test events from the log of test events based on the input;
generating a plurality of test databases, each respective said test database based on a respective edit made to the production database such that the plurality of test databases are different versions or configurations of the production database, one said test database to another;
testing operation of the plurality of test databases by replaying the set of test events against each of the plurality of test databases in which timing is maintained, one said test database to another, based on respective said timestamps;
comparing test results of the plurality of test databases, one said test database to another, to identify at least one difference attributable to the respective edits; and
presenting the at least one difference for display in a user interface.

2. The method as described in claim 1, wherein the obtaining includes obtaining the set of test events from the log of test events having a respective said timestamp that corresponds to the period of time.

3. The method as described in claim 1, wherein the testing includes identifying one or more operational issues of the plurality of test databases or verifying a fix related to performance or behavior addressed by the plurality of test databases.

4. The method as described in claim 1, wherein the presenting the at least one difference includes a result of a comparison of the operation of at least one test database of the plurality of test databases to operation of the production database.

5. (canceled)

6. (canceled)

7. The method as described in claim 61, wherein the presenting the at least one difference includes a result of a comparison of the operation of at least one test database of the plurality of test databases to operation of the production database along with the result of a comparison of the plurality of test databases, one said test database to another.

8. The method as described in claim 1, wherein the logging includes logging production results generated by processing the stream of database requests by the production database.

9. The method as described in claim 8, wherein the logging of the production results includes respective timestamps.

10. The method as described in claim 9, wherein the testing operation of the plurality of test databases is based at least in part on the production results.

11. (canceled)

12. A system comprising:
a processing device, and
a computer-readable storage medium storing instructions that, responsive to execution by the processing device, causes the processing device to perform operations including:
generating a plurality of test databases, each respective said test database based on a respective edit made to a production database such that the plurality of test databases are different versions or configurations of the production database, one said test database to another;
forwarding a stream of database requests that are transmitted to the production database to the plurality of test databases in real time;
testing operation of the plurality of test databases, one said test database to another, by:
monitoring test results of each of the plurality of test databases to the stream of database requests; and
comparing the monitored test results of each of the plurality of test databases, one said test database to another;
identifying at least one difference between the test results based on the testing, the at least one difference being attributable to the respective edits; and
presenting the at least one difference for display in a user interface.

13. (canceled)

14. (canceled)

15. The system as described in claim 12, wherein the testing includes testing operation of the plurality of test databases, respectively, with operation of the production database.

16. The system as described in claim 15, wherein the identifying further includes identifying one or more differences between one or more the test results and corresponding one or more of production results from the production database.

17. The system as described in claim 16, wherein the presenting includes presenting the one or more differences along with the at least one difference for display in the user interface.

18. One or more computer-readable storage media storing instructions that, responsive to execution by a processing device, causes the processing device to perform operations comprising:
receiving a stream of database requests directed to a production database;
forming a log of test events by logging the received database requests in real-time and in parallel with execution on the production database, each test event including a timestamp;
receiving an input specifying a period of time;
obtaining a set of test events from the log of test events based on the input;
generating a plurality of test databases, each respective said test database based on a respective edit made to the production database such that the plurality of test databases are different versions or configurations of the production database, one said test database to another;
testing operation of the plurality of test databases by replaying the set of test events against each of the plurality of test databases in which timing is maintained, one said test database to another, based on respective said timestamps-;
comparing test results of the plurality of test databases, one said test database to another, to identify at least one difference attributable to the respective edits; and
presenting the at least one difference for display in a user interface.

19. The one or more computer-readable storage media as described in claim 18, wherein the logging includes logging production results generated by processing the stream of database requests by the production database, in which, the logging of the production results includes respective timestamps.

20. The one or more computer-readable storage media as described in claim 19, wherein the testing operation of the plurality of test databases is based at least in part on the production results.

21. The method as described in claim 1, wherein the respective edit for each of the plurality of test databases comprises a change to at least one of a database schema, an index structure, or a query optimization setting of the production database.

22. The method as described in claim 1, wherein the at least one difference comprises a difference, among the plurality of test databases, in at least one of query execution time, resource utilization, or transaction throughput.

23. The method as described in claim 1, wherein the set of test events corresponds to a period of time during which performance degradation occurred in the production database.

24. The system as described in claim 12, wherein the operations further include identifying, based on the at least one difference, one of the plurality of test databases that exhibits a desired performance.

25. The one or more computer-readable storage media as described in claim 18, wherein presenting the at least one difference comprises displaying, in the user interface, an interactive graph or comparative chart of performance data of the plurality of test databases.
